(19) United States
(12) Patent Application Publication
(10) Pub. No.: US 2015/0310763 A1
(43) Pub. Date: Oct. 29, 2015

(54) Method of Using a Toothbrush with Palmar Grip Handle for Dexterity Rehabilitation

(71) Applicants: Megan Miller, Transfer, PA (US); Jared Grandy, Sharpsville, PA (US)

(72) Inventors: Megan Miller, Transfer, PA (US); Jared Grandy, Sharpsville, PA (US)

(21) Appl. No.: 14/694,351

(22) Filed: Apr. 23, 2015

Related U.S. Application Data
(60) Provisional application No. 61/983,871, filed on Apr. 24, 2014.

(51) Int. Cl. G09B 19/00; A46B 5/02

(52) U.S. Cl. CPC G09B 19/003; A46B 5/025; A46B 5/026; G09B 19/0084

(57) ABSTRACT

A method and apparatus for providing occupational therapy using a toothbrush with a palmar grip handle is provided. A plurality of toothbrushes may provide the palmar grip along a portion of the handle, where the palmar grips may be of various sizes. The palmar grip may be substantially spherical in shape, and sized and adapted to stimulate the central nervous system for improving muscle memory, thereby aiding in the rehabilitation of users suffering from central nervous system trauma. The set of toothbrushes may be used in such a manner where a user may become accustom to one size grip before using another size grip. The palmar grip may also be sized and adapted to prevent over-brushing for all users, as well as providing a more comfortable grip for those suffering from hand and join pain disorders, hand-weakness, manual dexterity ailments or fine motor impairments.

### CROSS-REFERENCE TO RELATED APPLICATION

This application claims the benefit of U.S. Provisional Patent Application Ser. No. 61/983,871 entitled “Easy Way to Hold Toothbrush” filed on Apr. 24, 2014, the contents of which are incorporated by reference as if fully set forth herein.

### FIELD OF INVENTION

The present invention relates to toothbrushes, and more particularly, to a toothbrush with a palmar grip for dexterity assistance, dexterity rehabilitation and over-brushing prevention.

### BACKGROUND OF INVENTION

Current standard toothbrushes require too great an amount of fine motor skills and/or strength to operate properly for those suffering from dexterity-related and/or hand-strength issues. These individuals may be suffering from arthritis and other joint-related pain or may be pediatric users with fingers too small to properly manipulate the toothbrush. The difficulty these users encounter is that ordinary toothbrushes require a fingertip grip due to the relatively small surface area grip of the toothbrush. One solution that has been recognized is to increase the size of the toothbrush grip. There currently exist specially made handles that may be attached to ordinary toothbrushes with generally rounded handles or gripping surfaces. These devices are problematic for the above-mentioned users when attaching and/or removing from the toothbrush due to the necessity of fine fingertip control. These devices are also problematic because they create a risk of over-brushing due to the mechanical advantage these grips will create with the toothbrush.

One intended consequence of the use of a larger, generally rounded handle on a toothbrush is that the user is forced to adopt a palmar grip. In patients that experience dexterity problems and weakness in the hands, it has been discovered that large surface areas facilitate a palmer grip which in turn increases the sensory response to their central nervous system, allowing for improved dexterity and control. When brushing one's teeth using a palmer grip, the user activates their upper arm, chest and shoulder muscles to manipulate the toothbrush, whereas a fingertip grip activates the forearm muscles for fine motor control. The result is that by using a palmer grip, an individual ends up using a much more powerful muscle group, and much greater force exerted to brush one's teeth.

Over-brushing of teeth and gums, the condition of using too much force with a toothbrush such that damage is caused, is a major concern of leading dental experts around the world. Dentists now recognize that ten to twenty percent of the population have damaged teeth and gums due to over-brushing. Tooth abrasion and receding gums may occur from over-brushing, both of which are irreversible. The current recommended prevention for over-brushing related damage is teaching proper tooth brushing technique. As discussed previously, however, those required to use a palmer toothbrush grip, activate their chest, shoulder and upper arm muscles, which make ordinary proper tooth brushing technique a challenge. In fact, those using the palmer grip are more at risk of over-brushing due to the larger muscle group and greater force potential used with brushing. This risk is further worsened by the mechanical advantage of the standard toothbrush handle, which is only amplified by toothbrushes designed to provide an ergonomically advantageous handle.

Other toothbrushes designed to provide an ergonomically advantageous handle for comfortable handling fail to convey the advantages and comfort to those with severe dexterity disorders, much less provides dexterity rehabilitation or over-brushing prevention. As can be seen, there is a need for a toothbrush with a palmar grip handle for dexterity assistance, dexterity rehabilitation and over-brushing prevention.

### SUMMARY OF INVENTION

A toothbrush adapted for a palmer grip is disclosed that contains a palmar grip attached to a toothbrush handle at a distance from the toothbrush head that reduces the mechanical advantage of the lever action of the toothbrush thereby reducing the risk of over-brushing for users with dexterity and/or hand strength related issues. The current invention also discloses that a palmar grip may be made of a unitary construction such that it solves the problem of assembling and/or disassembling the palmer grip onto a toothbrush. Additionally disclosed are methods to use multiple toothbrushes adapted for a palmer grip, with varying palmer grip sizes in an occupational therapy rehabilitation toolkit, so to provide therapy and training with the various sized toothbrush grips.

### BRIEF DESCRIPTION OF THE DRAWINGS

FIG. 1 is a perspective view of an exemplary embodiment of the present invention;

FIG. 2 is a reversed perspective view of an exemplary embodiment of the present invention;

FIG. 3 is a longitudinal cross-section view of an exemplary embodiment of the present invention, taken along line 3-3 in FIG. 1; and

FIG. 4 is a transverse cross-section view of an exemplary embodiment of the present invention, taken along line 4-4 in FIG. 3.

### DETAILED DESCRIPTION OF THE INVENTION

The following detailed description are the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a toothbrush with a palmar grip handle for dexterity assistance, dexterity rehabilitation and over-brushing prevention. The toothbrush may provide the palmar grip along a portion of the handle. The palmar grip may be substantially spherical in shape, and sized and adapted to stimulate the central nervous system for improving muscle memory, thereby aiding in rehabilitation of users suffering from central nervous system trauma. The palmar grip may also be sized, located and otherwise adapted to prevent over-brushing for all users, as well as proving a more comfortable grip for those suffering from hand and joint pain disorders, hand-weakness, manual dexterity ailments or fine motor impairments.

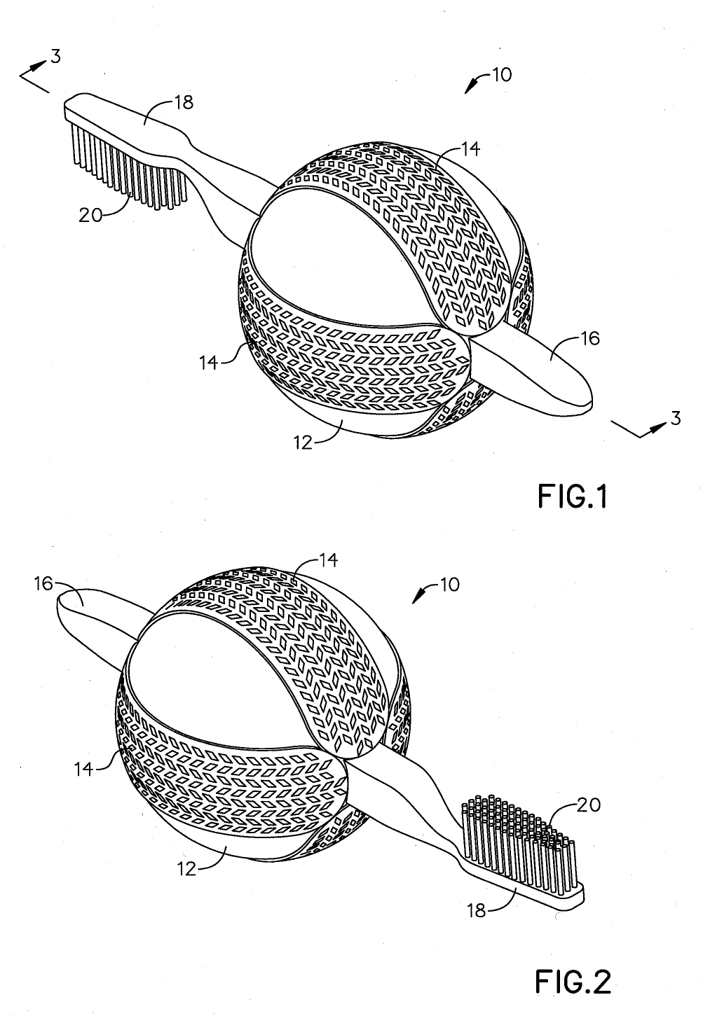

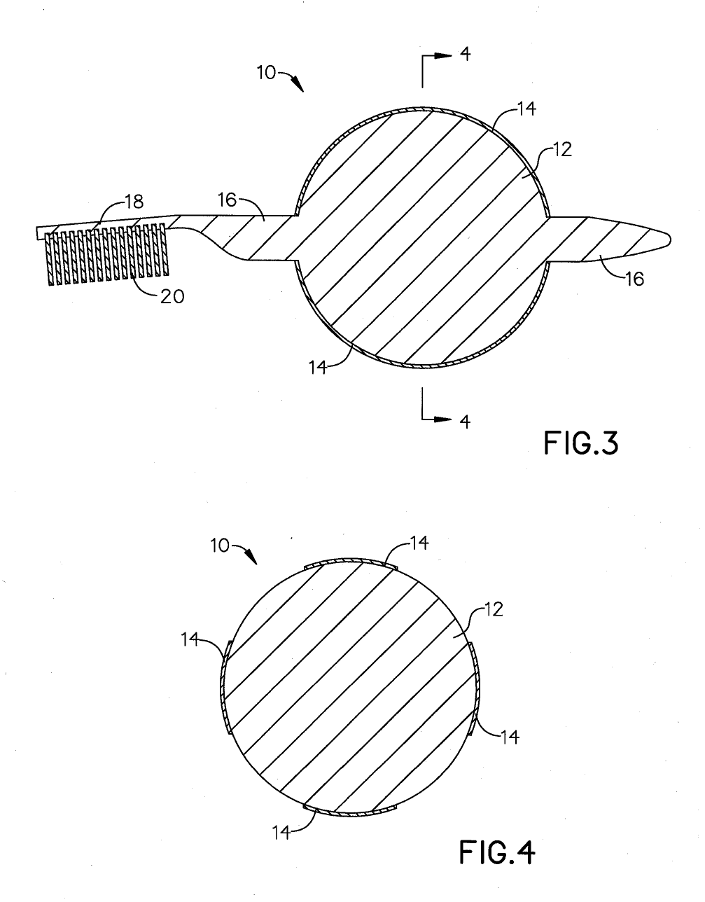

Referring to FIGS. 1 through 4, the present invention may include a toothbrush 10 providing a palmar grip 12 formed along a portion of a handle 16. The palmar grip 12 may be formed along the handle 16 such that the handle 16 passes through antipodal points of the grip 12. The handle 16 may also pass through the grip 12 such that the handle 16 does not pass through the midpoint of the grip 12. A tapered neck may interconnect one end of the handle 16 to a toothbrush head 18 providing a plurality of bristles 20 conducive for cleaning the teeth, gums and tongue of a user. The plurality of bristles 20 may be adapted to range in stiffness from hard to extra soft. The toothbrush head 18 may also be adapted for specialized use such as periodontal and post-surgical use. Alternative embodiments may also include the use of electric toothbrush heads and other electric toothbrush components incorporated into the principle embodiment.

A lever may be understood to be a simple machine where a rigid member rotates about a fulcrum and may magnify force and/or speed on the ends of the rigid member. The placement of the fulcrum on the rigid member determines the mechanical advantage or amount, which the input force may be multiplied or divided by the lever. In order to reduce the mechanical advantage the toothbrush head may have due to the lever action of the handle in conjunction with the user's hand, one embodiment may place the palmar grip 12 in a position where the palmar grip 12 is closer to the end of the handle 16 than the toothbrush head 18. By locating the palmer grip 12 closer to the end of the handle 16 than the toothbrush head 18, the toothbrush 10 may have its mechanical advantage reduced to less then one, where the length of the lever before the fulcrum where input energy is exerted, is less than the output distance, the length of the lever after the fulcrum where the magnified force may be felt. By lowering the mechanical advantage to less than one, the risk of over-brushing is reduced because the reduction in the force magnification of the lever results in less force being put on the user's teeth and gums for a given force applied to the handle. In one embodiment, the distance the toothbrush head 18 is from the palmer grip 12, as measured by the centermost point of the palmer grip 12, is at least four (4) inches. Of course, it is recognized that there are a variety of distance relationships that may be used to keep the mechanical advantage of the lever less than one, thereby reducing the risk of over-brushing.

The handle 16, neck, head 18 and palmar grip 12 may be made of suitable food-safe, non-flexible material, such as plastic, rubber and the like, to allow for easy cleaning and steady control. In certain embodiments, the palmar grip 12, handle 16 and head 18 forms a unitary construction facilitating manufacture and reducing overall costs thereof. Unitary construction also obviates the need to attach and remove the palmar grip 12 from the handle 16, which can be difficult for those which dexterity and/or hand strength issues. The palmar grip 12 may be solid or hollow and may of a similar or dissimilar material as the handle 16 and/or the toothbrush head 18.

The palmar grip 12 may be substantially spherical in shape, which may be sized and dimensioned to promote the natural comfort position of the hand including digits, to allow for steady, ambidextrous gripping, and to stimulate the central nervous system (CNS) for improving muscle memory, thereby aiding in the rehabilitation of most CNS-trauma patients. The palmar grip may be adapted to maximize the surface contact the grip may have with the palm and fingers of a hand while retaining a substantially spherical shape. In certain embodiments, the palmar grip 12 may have a range of sizes from large, medium, small and pediatric, ranging in circumference from nine and one-half (9.5) inches, eight (8) inches, six and one-half (6.5) inches and five (5) inches. The relatively large substantially spherical surface area facilitates a sensory response, as well as requires less of a range of finger motion to support the functionality of tooth brushing, thereby minimizing joint and hand pain for those who suffer from such disorders.

The palmar grip 12 may provide gripping surfaces 12 disposed thereon so as to provide an optimum non-slip grip when used. The gripping surface 12 may be made of a similar or dissimilar substance as the handle 16, neck, head 18 and palmar grip 12. In one embodiment the gripping surface may be made of rubber and may have a textured surface to further increase the surface area to provide a non-slip grip.

In one embodiment, the handle 16 may be of a length such that the bottom end of the handle may extend beyond the circumference of the palmar grip 12. The handle may be shaped such that is substantially box shaped with tapered ends. Alternatively, the handle may be substantially cylindrical shaped. In one embodiment the handle end may be adapted to be received in a toothbrush stand (not shown). In one embodiment, a toothbrush stand may be frustum of a cone with a substantially spherical depression on its top surface. In the center of the substantially spherical depression may be a hole adapted to receive the end of the handle 16. When the toothbrush 10 is inserted into the toothbrush holder it may stand substantially upright. The toothbrush stand may be used to prevent the toothbrush 10 from rolling on a bathroom counter and generally improves the cleanliness of the toothbrush 10. A toothbrush holder may also be adapted to retain the toothbrush 10 by other means such as clips, springs or magnets. In alternative embodiments the toothbrush holder may not require the length of the handle 16 to extend beyond the palmar grip 12.

A method of using the present invention may include the following. The toothbrush disclosed above may be provided. The toothbrush may come in four (4) different grip sizes: Pediatric, Small, Medium, and Large. The purpose of the sizes is to match the patient hands with the appropriate sized palmar grip 12 needed for gripping. For dexterity-impaired users, providing multiple sizes promotes the advantages of progressive “palmar gripping” and allows for easier performance of this ordinarily simple task. As the user becomes more accustomed to brushing with a palmer grip, they will improve their muscle memory, and gain fine control over the muscles used to manipulate the brush. This progress may be monitored and coached by physical or occupational therapists or other medical professionals. After sufficient skill and improvement is shown with a given size of the palmer grip 12, the user may “graduate” to use the next smaller available size, with a goal of returning to a standard or near standard toothbrush. In an alternative method, as pediatric patients age and grow, they can progress to larger grip sizes that allow for continued lifetime support. Alternatively, this method can be used in training young children on the task of tooth brushing while they may not yet possess their full array of fine motor skills. This method may be ideal for patients in rehabilitations, allowing for the dexterity progression from large grip size to small, whereby patients can rehabilitate between appointments.

It should be understood, of course, that the foregoing relates to exemplary embodiments of the invention and that modifications may be made without departing from the spirit and scope of the invention as set forth in the following claims.

I claim:

1. An occupational therapy rehabilitation toolkit comprising,
a plurality of toothbrushes each having,
a longitudinal member having a first end and a second end,
a toothbrush head affixed to said first end of said longitudinal member, and
a handle adapted for a palmar grip affixed to said longitudinal member,
where at least two toothbrushes have handles of a different size.

2. An occupational therapy rehabilitation toolkit of claim 1 where said handle of each toothbrush is affixed to said longitudinal member between said first end and said second end of said longitudinal member, where the distance between said first end and said handle is greater than the distance between said handle and said second end.

3. An occupational therapy rehabilitation toolkit of claim 1 where each said toothbrush is of a unitary construction.

4. An occupational therapy rehabilitation toolkit of claim 1 further comprising a toothbrush holder adapted to receive one said toothbrush such that said toothbrush is held substantially upright.

5. An occupational therapy rehabilitation toolkit of claim 1 where said second end of said longitudinal member of each toothbrush extends from said palmar grip such that said second end is adapted to be received in a toothbrush holder.

6. An occupational therapy rehabilitation toolkit of claim 5 further comprising a toothbrush holder adapted to receive said second end of said longitudinal member of one toothbrush.

7. An occupational therapy rehabilitation toolkit of claim 1 where said handle of each toothbrush is substantially spherical.

8. An occupational therapy rehabilitation toolkit of claim 1 where said distance between said toothbrush head and said handle is at least four inches for at least one toothbrush.

9. An occupational therapy rehabilitation toolkit of claim 7 where said longitudinal member of each toothbrush is affixed to said handle through the antipodal points of said handle.

10. An occupational therapy rehabilitation toolkit of claim 7 where at said handle of said toothbrushes have a circumference of at least five inches.

11. A method of occupational therapy rehabilitation comprising,
using a palmar grip on a first toothbrush adapted for a palmar grip of a first circumference for a first period of time,
using a palmar grip on a second toothbrush adapted for a palmar grip of a second circumference for a second period of time,
where said first circumference of said first toothbrush is larger than said second circumference of said second toothbrush.

12. A method of occupational therapy rehabilitation of claim 11 further comprising,
using a palmar grip on a third toothbrush adapted for a palmar grip of a third circumference for a third period of time,
where said third circumference of said third toothbrush is smaller than said second circumference of said second toothbrush.

13. A method of occupational therapy rehabilitation of claim 11 where said first time period occurs prior to said second time period.

14. A method of occupational therapy rehabilitation of claim 12 where said third time period occurs after to said second time period.

15. A method of occupational therapy rehabilitation of claim 11 where each said toothbrush has,
a longitudinal member having a first end and a second end,
a toothbrush head affixed to said first end of said longitudinal member, and
a handle adapted for a palmar grip affixed to said longitudinal member between said first end and said second end of said longitudinal member, where the distance between said first end and said handle is greater than the distance between said handle and said second end.

16. A method of occupational therapy rehabilitation of claim 14 further comprising, providing instruction on over-brushing prevention.

17. A method of occupational therapy rehabilitation comprising,
using a palmar grip on a first toothbrush adapted for a palmar grip of a first circumference for a first period of time,
using a palmar grip on a second toothbrush adapted for a palmar grip of a second circumference for a second period of time,
where said first circumference of said first toothbrush is smaller than said second circumference of said second toothbrush.

18. A method of occupational therapy rehabilitation of claim 17 further comprising,
using a palmar grip on a third toothbrush adapted for a palmar grip of a third circumference for a third period of time,
where said third circumference of said third toothbrush is larger than said second circumference of said second toothbrush.

19. A method of occupational therapy rehabilitation of claim 17 where said first time period occurs prior to said second time period.

20. A method of occupational therapy rehabilitation of claim 19 where said third time period occurs after to said second time period.
